(19) United States
(12) Patent Application Publication
(10) Pub. No.: US 2017/0064389 A1
(43) Pub. Date: Mar. 2, 2017

(54) TRANSMISSION APPARATUS, TRANSMISSION METHOD, RECEPTION APPARATUS, AND RECEPTION METHOD

(71) Applicant: SONY CORPORATION, TOKYO (JP)

(72) Inventor: SATOSHI TERAMOTO, SAITAMA (JP)

(21) Appl. No.: 15/119,430

(22) PCT Filed: Feb. 16, 2015
(86) PCT No.: PCT/JP2015/054083

§ 371 Date: Aug. 17, 2016

(30) Foreign Application Priority Data
Feb. 26, 2014 (JP) 2014-035679

(51) Int. Cl. H04N 21/442; H04N 21/443; H04N 21/858; H04N 21/4363; H04L 29/06

(52) U.S. Cl. CPC H04N 21/44231; H04N 21/43632; H04N 21/44227; H04L 69/24; H04N 21/8586; H04N 21/4436

(57) ABSTRACT

To allow the value of a link setting of a digital interface to be changed to the user's desired state in a timely manner. A transmission apparatus adjusts a link setting for a digital interface between the transmission apparatus and an external apparatus (reception apparatus), and transmits content data to the external apparatus through a transmission channel according to the value of the link setting. A reception apparatus adjusts a link setting for a digital interface between the reception apparatus and an external apparatus (transmission apparatus), and receives content data from the external apparatus through a transmission channel according to the value of the link setting. The transmission apparatus and the reception apparatus adjust the link settings for the digital interfaces according to setting information about a link mode.

### TECHNICAL FIELD

The present technology relates to transmission apparatuses, transmission methods, reception apparatuses, and reception methods. In particular, the present technology relates to, for example, a transmission apparatus for transmitting content data through a digital interface.

### BACKGROUND ART

The Mobile High-definition Link (MHL) standard has in recent years been proposed for a communication interface that allows high-speed transmission of image and audio data from a transmitter (source apparatus) to a receiver (sink apparatus). The MHL standard is an interface standard for high-speed video transmission.

In conventional MHL connections, for example, as described in Patent Literature 1, once a link has been set under constraint conditions for a transmitter and a receiver, the state is maintained. Therefore, the value of the link setting cannot be changed to the user's desired state in a timely manner.

### CITATION LIST

### Patent Literature

Patent Literature 1: JP 2014-002448A

### SUMMARY OF INVENTION

### Technical Problem

It is an object of the present technology to allow the value of a link setting of a digital interface to be changed to the user's desired state in a timely manner.

### Solution to Problem

A concept of the present technology is a transmission apparatus including: a transmission unit configured to adjust a link setting for a digital interface between the transmission apparatus and an external apparatus, and transmit content data to the external apparatus through a transmission channel according to a value of the link setting. The transmission unit adjusts the link setting for the digital interface according to setting information about a link mode.

In the present technology, the transmission unit adjusts a link setting for a digital interface between the transmission apparatus and an external apparatus, and transmits content data to the external apparatus through a transmission channel according to a value of the link setting. For example, the digital interface may be an interface compliant with the Mobile High-definition Link (MHL) standard.

The transmission unit adjusts the link setting for the digital interface according to setting information about a link mode. For example, the link mode may have options including at least any one of a performance priority mode in which performance of the apparatus is a high priority, a content priority mode in which a setting is changed according to the type of a content, and an energy saving mode in which power consumption of the apparatus is reduced.

Thus, in the present technology, a link setting for a digital interface with respect to an external apparatus is adjusted according to setting information about a link mode. Therefore, the value of the link setting for the digital interface can be adjusted to the user's desired state in a timely manner.

In the present technology, for example, a link mode setting unit configured to select and set one of a plurality of link modes may be further included. When the link mode set by the link mode setting unit is the same as a link mode set in the external apparatus, the transmission unit may adjust the link setting for the digital interface to a value corresponding to the link mode which is the same between the transmission apparatus and the external apparatus. In this case, the link setting can be adjusted according to the value corresponding to the same link mode that is set in the transmission apparatus and the external apparatus.

For example, the transmission unit may be notified by the external apparatus that the link mode set by the link mode setting unit is the same as the link mode set in the external apparatus. In this case, the transmission apparatus can acquire information about whether the link mode set in the transmission apparatus is the same as the link mode set in the external apparatus, without doing such determination by itself.

For example, a display control unit configured to control a display of a user interface screen for setting of a link mode performed in the link mode setting unit may be further included. In this case, the user can easily and appropriately set the link mode according to the user interface screen.

Another concept of the present technology is a reception apparatus including: a reception unit configured to adjust a link setting for a digital interface between the reception apparatus and an external apparatus, and receive content data from the external apparatus through a transmission channel according to a value of the link setting. The reception unit adjusts the link setting for the digital interface according to setting information about a link mode.

In the present technology, the reception unit adjusts a link setting for a digital interface between the reception apparatus and an external apparatus, and receives content data from the external apparatus through a transmission channel according to a value of the link setting. For example, the digital interface may be an interface compliant with the Mobile High-definition Link (MHL) standard.

The reception unit adjusts the link setting for the digital interface according to setting information about a link mode. For example, the link mode may have options including at least any one of a performance priority mode in which performance of the apparatus is a high priority, a content priority mode in which a setting is changed according to the type of a content, and an energy saving mode in which power consumption of the apparatus is reduced.

Thus, in the present technology, a link setting for a digital interface with respect to an external apparatus is adjusted according to setting information about a link mode. Therefore, the value of the link setting for the digital interface can be adjusted to the user's desired state in a timely manner.

In the present technology, for example, a link mode setting unit configured to select and set one of a plurality of link modes may be further included. When the link mode set by the link mode setting unit is the same as a link mode set in the external apparatus, the reception unit may adjust the link setting for the digital interface to a value corresponding to the link mode which is the same between the reception apparatus and the external apparatus. In this case, the link setting can be adjusted according to the value corresponding to the same link mode that is set in the reception apparatus and the external apparatus.

The reception unit may receive, from the external apparatus, the value corresponding to the link mode which is the same between the reception apparatus and the external apparatus. In this case, the reception apparatus can easily cause its own link setting to be the same as the link setting set in the external apparatus.

For example, a display control unit configured to perform control to provide an alert display when the link mode set by the link mode setting unit is not the same as the link mode set in the external apparatus may be further included. In this case, the user can easily cause the link setting to be the same as the link setting set in the external apparatus according to the alerting display.

For example, a display control unit configured to control a display of a user interface screen for setting of a link mode performed in the link mode setting unit may be further included. In this case, the user can easily and appropriately set the link mode according to the user interface screen.

### Advantageous Effects of Invention

According to the present technology, the value of a link setting for a digital interface can be changed to the user's desired state in a timely manner. Note that the advantageous effects described herein are merely illustrative and not restrictive, and there may be additional advantageous effects.

### BRIEF DESCRIPTION OF DRAWINGS

FIG. 1 is a block diagram showing a configuration example of an image display system according to an embodiment.

FIG. 2 is a block diagram showing a configuration example of a mobile phone included in an image display system.

FIG. 3 is a block diagram showing a configuration example of a television set included in an image display system.

FIG. 4 is a diagram showing a configuration example of an MHL transmission unit in a mobile phone and an MHL reception unit in a television set.

FIG. 5 is a flowchart schematically showing an example of a process procedure performed by an MHL transmission unit in a mobile phone and an MHL reception unit in a television set during connection therebetween.

FIG. 6 is a flowchart schematically showing an example of a process procedure performed by an MHL transmission unit in a mobile phone and an MHL reception unit in a television set after a link therebetween has been established.

FIG. 7 is a diagram showing an example of a user interface screen for setting an intelligent link mode.

FIG. 8 is a diagram showing an example of an alerting user interface screen which is displayed when a mobile phone and a television set have different intelligent link mode settings.

FIG. 9 is a block diagram showing a configuration example of a digital camera as another example of an MHL source apparatus.

### DESCRIPTION OF EMBODIMENT(S)

Modes for carrying out the present invention (hereinafter referred to as “embodiments”) will now be described. Note that description will be provided in the following order.

1. Embodiments

2. Variations

### 1. Embodiments

### Image Display System

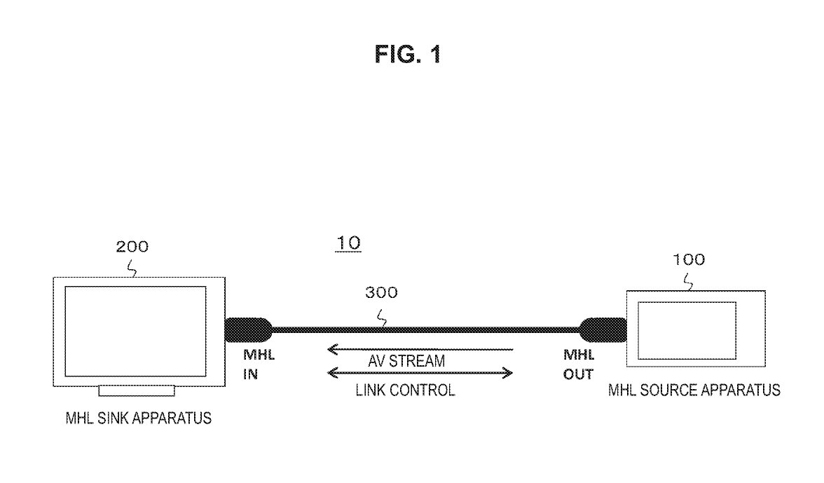

FIG. 1 shows a configuration example of an image display system 10 according to an embodiment. The image display system 10 includes a mobile phone 100 as a Mobile High-definition Link (MHL) source apparatus, and a television set 200 as an MHL sink apparatus. These apparatuses are connected together by an MHL cable 300 as a transmission channel.

An overview of MHL will be described. MHL is an audio visual (AV) digital interface standard for, mainly, mobile apparatuses. According to MHL, an MHL source apparatus and an MHL sink apparatus are connected together by an MHL cable, and contents, such as moving images, still images, sounds, and the like, possessed by the MHL source apparatus are played back by the MHL sink apparatus (AV stream/unidirectional). Also, controls such as reading of EDID, HDCP authentication, reading/writing of a register, control of a remote controller, and the like are performed by transmission and reception of a DDC command and an MHL sideband channel (MSC) command between the apparatuses (link control/bidirectional).

The mobile phone 100 and the television set 200 adjust settings for a link between these apparatuses, and exchange content data through the MHL cable 300 according to the values of the link settings. The mobile phone 100 and the television set 200 each adjust settings for the MHL link according to setting information about the intelligent link mode. The link settings will be described in detail below.

In this embodiment, the intelligent link mode has options including at least any one of the performance priority mode, the content priority mode, and the energy saving mode. The user selects and sets one of the plurality of link modes in both of the mobile phone 100 and the television set 200. The mobile phone 100 and the television set 200 adjust the link settings to values corresponding to the link mode which is the same between the mobile phone 100 and the television set 200.

The performance priority mode is a link mode in which the performance of an apparatus is a high priority. The performance of an apparatus includes, for example, a supported resolution, a supported frame rate, a color depth, a color space, a TMDS clock speed, and the like described below. In the performance priority mode, the link settings are adjusted so that all of these items of performance are maximized (corresponding to the initial link settings).
Supported resolution (e.g., FHD, 4K)
Supported frame rate (e.g., 30 P, 60 P)
Color depth (e.g., 8 bits, 10 bits)
Color space (e.g., deep color, XVYCC)
TMDS clock speed (e.g., 600 M, 300 M)

The content priority mode is a link mode in which settings are changed according to the type of a content. The content types include, for example, sports, movies, games, photos, and the like.

Sports: Priority frame rate

Movies: Priority resolution, color space, color depth

Games: Priority delay time

Photos: Priority resolution, color space, color depth

In the content priority mode, when the content type is sports, the link settings are adjusted so that the frame rate is a high priority. In the content priority mode, when the content type is movies, the link settings are adjusted so that the resolution, color space, and color depth are a high priority. In the content priority mode, when the content type is games, the link settings are adjusted so that the delay time is a high priority. In the content priority mode, when the content type is photos, the link settings are adjusted so that the resolution, color space, and color depth are a high priority.

The energy saving mode is a link mode in which the power consumption of an apparatus is minimized. In this case, parameters which are changed include, for example, a supported resolution, a supported frame rate, a TMDS clock speed, and the like described below.
Supported resolution (e.g., FHD, 4K)
Supported frame rate (e.g., 30 P, 60 P)
TMDS clock speed (e.g., 600 M, 300 M)

[Configurations of Mobile Phone and Television Set]

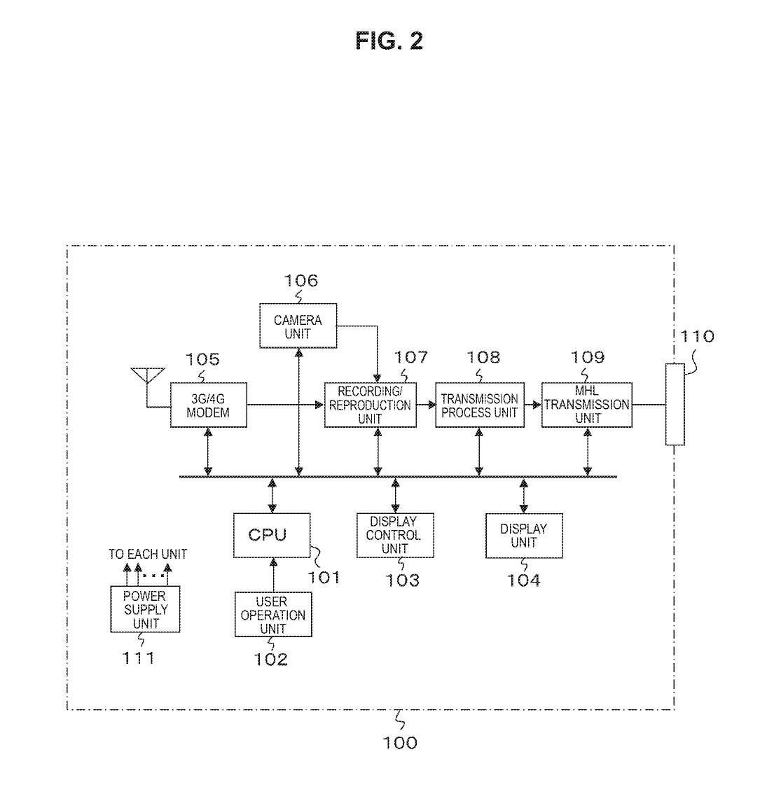

FIG. 2 shows a configuration example of the mobile phone 100. The mobile phone 100 includes a CPU 101 as a control unit, a user operation unit 102, a display control unit 103, a display unit 104, a 3G/4G modem unit 105, a camera unit 106, a recording/reproduction unit 107, a transmission process unit 108, an MHL transmission unit 109, an MHL terminal 110, and a power supply unit 111.

The CPU 101 controls an operation of each unit of the mobile phone 100. The user operation unit 102 and the display unit 104 form a user interface. The user operation unit 102 is connected to the CPU 101. The user operation unit 102 includes a key, button, dial, or switch which is provided on a housing (not shown) of the mobile phone 100, or a touch panel provided on a display surface of the display unit 104, or a mouse or keyboard, or a gesture input unit which performs detection using a camera, or a voice input unit which performs detection using a microphone, or a remotely controlled transmitter/receiver, or the like.

The display control unit 103 controls the display of the display unit 104. The display unit 104 includes, for example, a liquid crystal display (LCD), an organic electro-luminescence (EL) panel, or the like. Note that, in this embodiment, an example is illustrated in which the display control unit 103 is provided in addition to the CPU 101. Alternatively, the CPU 101 may directly control the display of the display unit 104. The CPU 101 and the display control unit 103 may be implemented as a single chip or a plurality of cores. The power supply unit 111 supplies power to each unit of the mobile phone 100. The power supply unit 111 may be an AC power supply or a battery (a rechargeable battery or a dry cell battery).

The 3G/4G modem 105 performs mobile telephone communication. The camera unit 106 captures a moving image and a still image. The recording/reproduction unit 107 drives an internal memory (non-volatile memory), or a recording medium such as a memory card or the like, for recording or retrieval (writing or reading). The recording/reproduction unit 107 performs recording/reproduction of a call through the modem 105. The recording/reproduction unit 107 also performs recording/reproduction of image data (a moving image, a still image) and audio data acquired through the modem 105, recording/reproduction of image data (a moving image, a still image) and audio data captured and acquired by a camera unit (including a microphone) 106, or the like. Note that the recording/reproduction unit 107 also performs a codec process for data compression on image data (a moving image, a still image) captured and acquired by the camera unit 106.

The user can instruct the display unit 104, using the user operation unit 102, to display a list of contents recorded in a recording medium included in the recording/reproduction unit 107. When the user chooses any one from the content list using the user operation unit 102, the data of the chosen content is reproduced from the recording medium by the recording/reproduction unit 107, and transferred to the transmission process unit 108.

Note that the image data and audio data acquired by the 3G/4G modem 105 or the image data and audio data acquired by the camera unit 106 may be transmitted in real time. In this case, the content data is directly transferred to the transmission process unit 108, although not shown. Alternatively, a memory card may be inserted into another device, which then writes content data into the memory card, and thereafter inserted into the recording/reproduction unit 107 so that the content data is transferred to the transmission process unit 108.

The transmission process unit 108 processes and adjusts the resolution, frame rate, color depth, color space, and the like of image data which has been supplied from the recording/reproduction unit 107 and is to be transferred to the television set 200, to the values of the link settings in the MHL transmission unit 109. The MHL transmission unit 109 is connected to the MHL terminal 110. The MHL transmission unit 109 unidirectionally transmits data (content data) of an image, sounds, and the like processed by the transmission process unit 108, from the MHL terminal 110 to the television set 200 through the MHL cable 300, by communication compliant with the MHL standard. The MHL transmission unit 109 will be described in detail below.

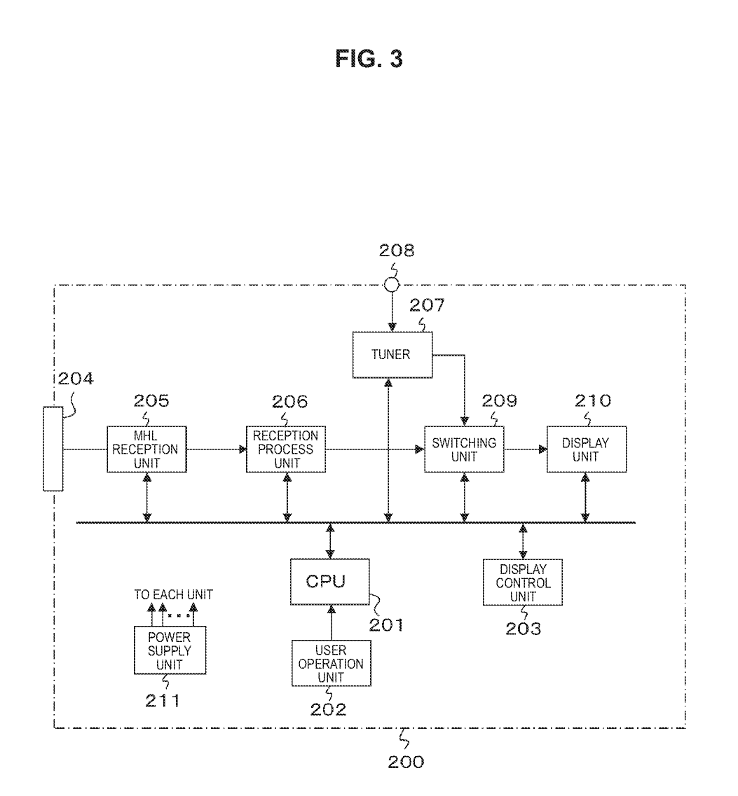

FIG. 3 shows a configuration example of the television set 200. The television set 200 has a CPU 201 as a control unit, a user operation unit 202, a display control unit 203, an MHL terminal 204, an MHL reception unit 205, a reception process unit 206, a tuner 207, an antenna terminal 208, a switching unit 209, a display unit 210, and a power supply unit 211.

The control unit 201 controls an operation of each unit of the television set 200. The user operation unit 202 forms a user interface, and is connected to the control unit 201. The user operation unit 202 includes a key, button, dial, or switch which is provided on a housing (not shown) of the reception apparatus 200, or a touch panel provided on a display surface of the display unit 210, or a mouse or keyboard, or a gesture input unit which performs detection using a camera, or a voice input unit which performs detection using a microphone, or a remotely controlled transmitter/receiver, or the like.

The display control unit 203 controls the display of the display unit 210. The display unit 210 includes, for example, a liquid crystal display (LCD), an organic electro-luminescence (EL) panel, or the like. Note that, in this embodiment, an example is illustrated in which the display control unit 203 is provided in addition to the CPU 201. Alternatively, the CPU 201 may directly control the display of the display unit 210. The CPU 201 and the display control unit 203 may be implemented as a single chip or a plurality of cores. The power supply unit 211 supplies power to each unit of the television set 200. The power supply unit 211 may be an AC power supply or a battery (a rechargeable battery or a dry cell battery).

The MHL reception unit 205 is connected to the MHL terminal 204. The MHL reception unit 205 receives data (content data) of an image, sounds, and the like unidirectionally transmitted from the MHL transmission unit 109 of the mobile phone 100 connected thereto through the MHL cable 300, by communication compliant with the MHL standard. The MHL reception unit 205 sends the received image data to the reception process unit 206. Note that the audio data received by the MHL reception unit 205 is supplied to an audio data reception process unit (not shown). The MHL reception unit 205 will be described in detail below.

The reception process unit 206 performs a necessary process such as a scaling process (resolution conversion process), gamma correction, or the like on the image data acquired by the MHL reception unit 205. The reception process unit 206 supplies the processed image data to the switching unit 209.

The tuner 207 receives a broadcasting-satellite service, a digital terrestrial broadcasting service, or the like. The tuner 207 is supplied with a broadcast signal captured by an antenna (not shown) connected to the antenna terminal 208. The tuner 207 acquires the image data (video signal) and audio data of a predetermined program on the basis of a broadcast signal. The switching unit 209 selectively obtains image data processed by the reception process unit 206 or image data acquired the tuner 207, and supplies the image data to the display unit 210.

Operations of the mobile phone 100 shown in FIG. 2 and the television set 200 shown in FIG. 3 will be briefly described. Content data reproduced from the recording/reproduction unit 207 of the mobile phone 100, or content data acquired by the 3G/4G modem 105, or content data acquired by the camera unit 106, is supplied to the transmission process unit 108.

The transmission process unit 108 processes and adjusts the resolution, frame rate, color depth, color space, and the like of image data to be transmitted to the television set 200, to the values of the link settings in the MHL transmission unit 109. The MHL transmission unit 109 unidirectionally transmits the content data processed by the transmission process unit 108 from the MHL terminal 110 to the television set 200 through the MHL cable 300, by communication compliant with the MHL standard.

The MHL reception unit 205 of the television set 200 receives content data unidirectionally transmitted from the MHL transmission unit 109 of the mobile phone 100 through the MHL cable 300, by communication compliant with the MHL standard. Image data received by the MHL reception unit 205 is transferred to the reception process unit 206, which then performs a scaling process (resolution conversion process), gamma correction, or the like on the image data. The processed image data is supplied to the switching unit 209.

The tuner 207 receives a broadcasting-satellite service, a digital terrestrial broadcasting service, or the like. Image data acquired by the tuner 207 is supplied to the switching unit 209. The switching unit 209 selectively obtains image data processed by the reception process unit 206 or image data acquired the tuner 207, and supplies the image data to the display unit 210.

[Configurations of MHL Transmission Unit and MHL Reception Unit]

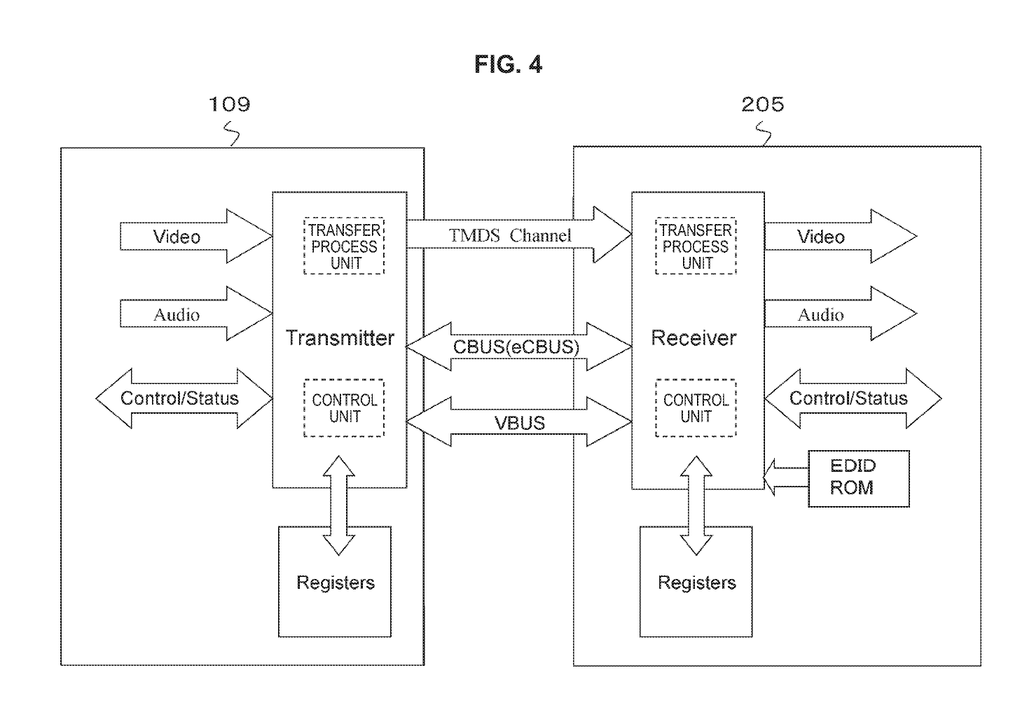

FIG. 4 shows a configuration example of the MHL transmission unit 109 of the mobile phone 100 of FIG. 2, and a configuration example of the MHL reception unit 205 of the television set 200 of FIG. 3. The MHL transmission unit 109 includes a transmitter, and the MHL reception unit 205 includes a receiver. The MHL transmission unit 109 and the MHL reception unit 205 are connected together by five lines (MHL+, MHL−, CBUS, VBUS, and GND) through pins and MHL cables. Pin assignment varies depending on the connector, and therefore, will not be described herein. The lines “MHL+” and “MHL−,” which is a twisted pair, are used to transfer AV streams and a synchronization signal (MHL clocks) therefor.

CBUS is used to bidirectionally transfer a DDC command and an MSC command. A DDC command is used for reading of EDID or HDCP authentication. An MSC command is used for EDID reading control, reading/writing of various registers, control of a remote controller, and the like. VBUS is used to supply a power of +5 V from the MHL sink apparatus to the MHL source apparatus or from the MHL source apparatus to the MHL sink apparatus.

[Link Settings in MHL Transmission Unit and MHL Reception Unit]

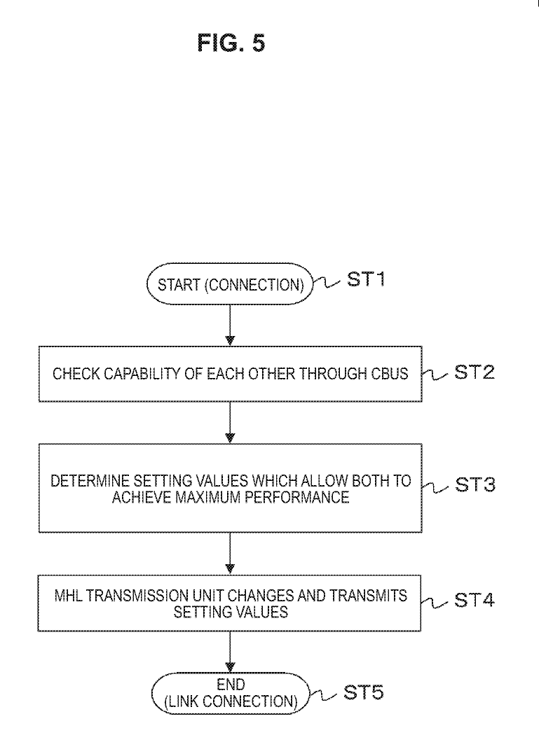

When the mobile phone 100 and the television set 200 are connected together by the MHL cable 300, the link settings are adjusted. FIG. 5 is a flowchart schematically showing an example of a process procedure performed the MHL transmission unit 109 and the MHL reception unit 205 during connection therebetween.

When the MHL transmission unit 109 and the MHL reception unit 205 are connected together in step ST1, control proceeds to step ST2. In step ST2, the MHL transmission unit 109 and the MHL reception unit 205 each check the capability of the other through CBUS (eCBUS). Specifically, capability information is read from a register of the MHL reception unit 205, and then transferred to the MHL transmission unit 109 through CBUS (eCBUS). Meanwhile, capability information is read from a register of the MHL transmission unit 109, and then transferred to the MHL reception unit 205 through CBUS (eCBUS).

The capability includes, for example:
Supported resolution (e.g., FHD, 4K)
Supported frame rate (e.g., 30 P, 60 P)
Color depth (e.g., 8 bits, 10 bits)
Color space (e.g., deep color, XVYCC)
TMDS clock speed (e.g., 600 M, 300 M)

Next, in step ST3, the control units of the MHL transmission unit 109 and the MHL reception unit 205 each check the capability of the other, and determine setting values which allow both of them to achieve maximum performance. Next, in step ST4, the MHL transmission unit 109 changes the settings values to those determined in step ST3, and transmits content data through the TMDS line (TMDS data line). Thereafter, in step ST5, a link is provided or established between the MHL transmission unit 109 and the MHL reception unit 205.

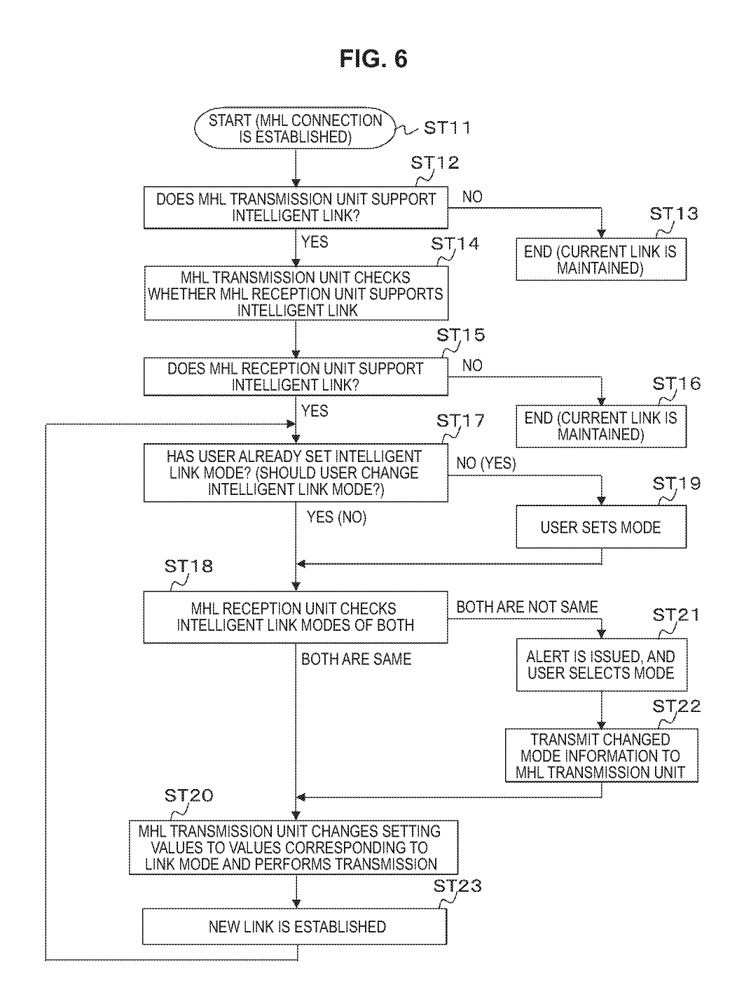

FIG. 6 is a flowchart schematically showing an example of a process procedure performed by the MHL transmission unit 109 and the MHL reception unit 205 after the link of FIG. 5 has been established. In step ST11, the MHL transmission unit 109 and the MHL reception unit 205 are connected together to establish a link, and then control proceeds to step ST12.

In step ST12, the MHL transmission unit 109 determines whether the MHL transmission unit 109 itself supports an intelligent link. If the determination result is negative, the process is ended while the current link state remains in step ST13. Meanwhile, if the determination result is positive, the MHL transmission unit 109 notifies the MHL reception unit 205 through CBUS (eCBUS) that the MHL transmission unit 109 supports an intelligent link.

In step ST14, the MHL transmission unit 109 checks whether the MHL reception unit 205 supports an intelligent link. Thereafter, in step ST15, the MHL transmission unit 109 determines whether the MHL reception unit 205 supports an intelligent link. If the determination result is negative, the process is ended while the current link state remains in step ST16. Meanwhile, if the determination result is positive, control proceeds to step ST17.

In step ST17, the MHL transmission unit 109 and the MHL reception unit 205 both determine whether the MHL transmission unit 109 and the MHL reception unit 205, respectively, are in an intelligent link mode. If the determination result is positive, control proceeds to step ST18. Meanwhile, if the determination result is negative, the user sets a link mode in step ST19, and then control proceeds to step ST18.

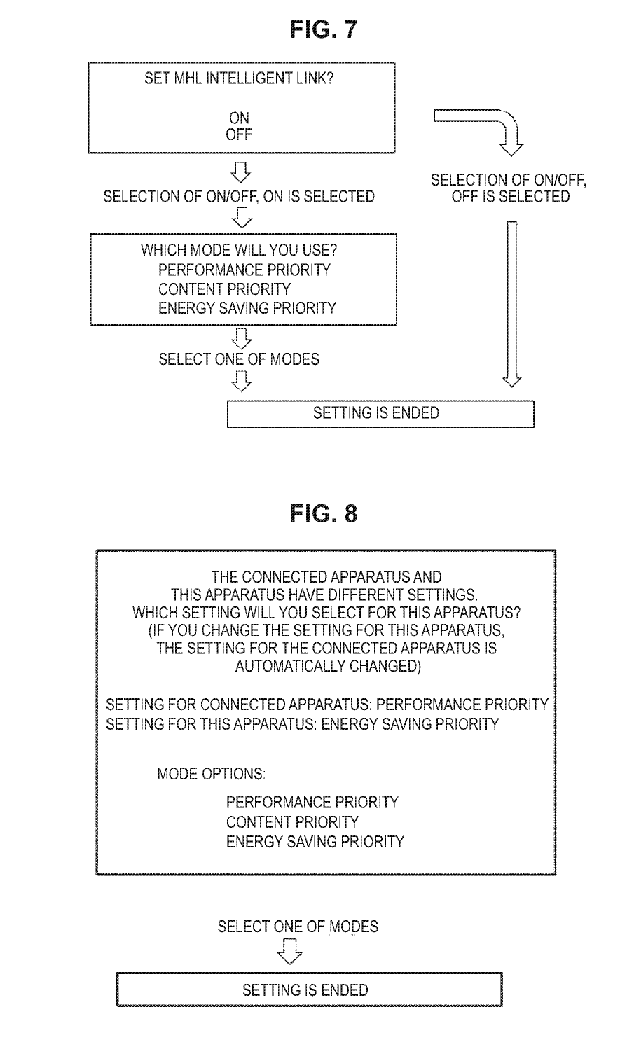

In this case, the mobile phone 100 and the television set 200 both display a user interface screen (UI screen) on which the user sets an intelligent link mode. When the UI screen is displayed, the user can easily and appropriately set an intelligent link mode. FIG. 7 shows an example of the UI screen for setting an intelligent link mode.

Initially, a message “Set the MHL Intelligent Link?” is displayed. If “off” is selected, a message “Setting is ended,” setting is ended. Meanwhile, if “on” is selected, “Which mode will you use?” is displayed. If one of performance priority, content priority, and energy-saving priority is selected, a message “Setting is ended” is displayed, and setting is ended.

Referring back to FIG. 6, in step ST18, the MHL reception unit 205 checks the intelligent link mode of each of the MHL reception unit 205 and the MHL transmission unit 109. The MHL reception unit 205 receives information about the intelligent link mode set by the MHL transmission unit 109, from the MHL transmission unit 109 through CBUS (eCBUS).

If both are the same, the MHL reception unit 205 notifies the MHL transmission unit 109 through CBUS (eCBUS) that both are the same, and control proceeds to step ST20. Specifically, the MHL transmission unit 109 is notified by the MHL reception unit 205 that the intelligent link mode of the MHL transmission unit 109 is the same as that which is set in the MHL reception unit 205. In this case, the MHL transmission unit 109 can obtain information about whether the intelligent link mode of the MHL transmission unit 109 is the same as that which is set in the MHL reception unit 205, without doing such determination by itself.

If both are not the same, the television set 200 displays a user interface screen (UI screen) indicating an alert in step ST21. When this alerting UI screen is displayed, the user can easily cause the intelligent link mode setting to be the same as the intelligent link mode setting in the mobile phone 100.

FIG. 8 shows an example of the alerting UI screen. Initially, a message “This apparatus and the connected apparatus have different settings. Which setting will you select for this apparatus? (If you change the setting for this apparatus, the setting for the connected apparatus is automatically changed)” is displayed. This alerting display allows the user to select and set the desired intelligent link mode. A message “Setting is ended” is displayed, and setting is ended.

Referring back to FIG. 6, next, in step ST22, the MHL reception unit 205 transmits the changed mode information to the MHL transmission unit 109 through CBUS (eCBUS). Thereafter, control proceeds to step ST20. In step ST20, the MHL transmission unit 109 changes setting values according to the intelligent link mode which is the same between the MHL reception unit 205 and the MHL transmission unit 109, and transmits content data through the TMDS line (TMDS data line).

In this case, the control unit of the MHL transmission unit 109 controls a transfer process unit to change settings. The MHL transmission unit 109 sends the values of the changed settings to the control unit of the MHL reception unit 205 through CBUS (eCBUS). In this case, the MHL reception unit 205 can easily cause its own link settings to be the same as the link settings for the MHL transmission unit 109. The MHL reception unit 205 newly changes the link settings, and processes content data transmitted from the MHL transmission unit 109 using a transfer process unit according to the values of the settings.

In step ST23, after a new link has been established, control returns to step ST17. As a result, even after a new link has been established, a change in the intelligent link mode, and a change in the content type if in the content priority mode, continue to be monitored. When a change occurs, the link settings are newly adjusted according to the change.

As described above, in the image display system 10 shown in FIG. 1, the MHL link settings are adjusted between the mobile phone 100 and the television set 200 according to setting information about the intelligent link mode. Therefore, for example, the values of the MHL link settings can be changed to the user's desired state at any appropriate time.

For example, when the content mode has been selected, a resolution and frame rate which are most suitable for a content can be obtained. Specifically, when the content type is sports or games, the link settings are adjusted to a high frame rate. When the content type is photos or movies, the link settings are adjusted to a high resolution. For example, when the energy saving mode has been selected, the power consumption of the device is reduced by optimizing the transfer rate, resulting in a decrease in heat generation or an increase in battery life, or the like. When the performance priority mode has been selected, the performance of the apparatus can be maximized.

### 2. Variations

Note that, in the above embodiments, examples have been illustrated in which the MHL source apparatus is the mobile phone 100 and the MHL sink apparatus is the television set 200. However, of course, the present technology can be similarly applied to other transmission apparatuses and reception apparatuses.

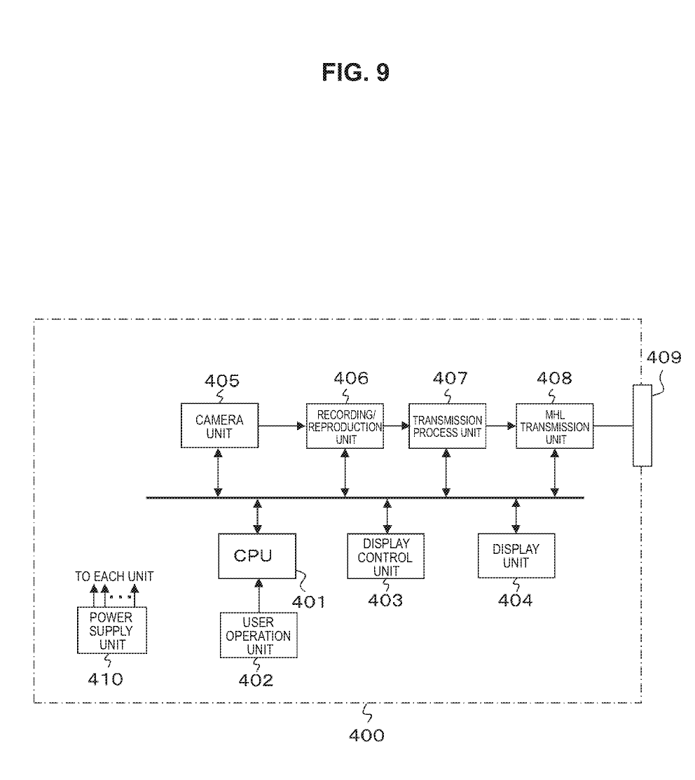

FIG. 9 shows a configuration example of a digital camera 400 as an MHL source apparatus. The digital camera 400 has a CPU 401 as a control unit, a user operation unit 402, a display control unit 403, a display unit 404, a camera unit 405, a recording/reproduction unit 406, a transmission process unit 407, an MHL transmission unit 408, an MHL terminal 409, and a power supply unit 410.

The CPU 401 controls an operation of each unit of the digital camera 400. The user operation unit 402 and the display unit 404 form a user interface. The user operation unit 402 is connected to the CPU 401. The user operation unit 402 includes a key, button, dial, or switch which is provided on a housing (not shown) of the digital camera 400, or a touch panel provided on a display surface of the display unit 404, or a mouse or keyboard, or a gesture input unit which performs detection using a camera, or a voice input unit which performs detection using a microphone, or a remotely controlled transmitter/receiver, or the like.

The display control unit 403 controls the display of the display unit 404. The display unit 404 includes, for example, a liquid crystal display (LCD), an organic electro-luminescence (EL) panel, or the like. Note that, in this embodiment, an example is illustrated in which the display control unit 403 is provided in addition to the CPU 401. Alternatively, the CPU 401 may directly control the display of the display unit 404. The CPU 401 and the display control unit 403 may be implemented as a single chip or a plurality of cores. The power supply unit 410 supplies power to each unit of the digital camera 400. The power supply unit 410 may be an AC power supply or a battery (a rechargeable battery or a dry cell battery).

The camera unit 405 captures a moving image or a still image. The recording/reproduction unit 406 drives an internal memory (non-volatile memory), or a recording medium such as a memory card or the like, for recording or retrieval (writing or reading). The recording/reproduction unit 406 performs recording/reproduction of image data (a moving image, a still image) and audio data captured and acquired by a camera unit (including a microphone) 405, or the like. Note that the recording/reproduction unit 406 also performs a codec process for data compression on image data (a moving image, a still image) captured and acquired by the camera unit 405.

The user can instruct the display unit 404, using the user operation unit 402, to display a list of contents recorded in a recording medium included in the recording/reproduction unit 406. When the user chooses any one from the content list using the user operation unit 402, the data of the chosen content is reproduced from the recording medium by the recording/reproduction unit 406, and transferred to the transmission process unit 407.

Note that the image data and audio data acquired by the camera unit 405 may be transmitted in real time. In this case, the content data is directly transferred to the transmission process unit 407, although not shown. Alternatively, a memory card may be inserted into another device, which then writes content data into the memory card, and thereafter inserted into the recording/reproduction unit 406 so that the content data is transferred to the transmission process unit 407.

The transmission process unit 407 processes and adjusts the resolution, frame rate, color depth, color space, and the like of image data which has been supplied from the recording/reproduction unit 406 and is to be transferred to the television set 200, to the values of the link settings in the MHL transmission unit 408. The MHL transmission unit 408 is connected to the MHL terminal 409. The MHL transmission unit 408 unidirectionally transmits data (content data) of an image, sounds, and the like processed by the transmission process unit 407, from the MHL terminal 409 to the television set 200 through the MHL cable 300, by communication compliant with the MHL standard.

In the above embodiments, examples of the present technology have been illustrated in which a transmitter and a receiver are connected together by an MHL digital interface. However, the present technology can be similarly applied to a case where a transmitter and a receiver are connected together by other digital interfaces, such as HDMI and the like. Note that “HDMI” and “MHL” are a registered trademark.

Additionally, the present technology may also be configured as below.

(1)

A transmission apparatus including:

a transmission unit configured to adjust a link setting for a digital interface between the transmission apparatus and an external apparatus, and transmit content data to the external apparatus through a transmission channel according to a value of the link setting,

wherein the transmission unit adjusts the link setting for the digital interface according to setting information about a link mode.

(2)

The transmission apparatus according to (1), further including:

a link mode setting unit configured to select and set one of a plurality of link modes,

wherein when the link mode set by the link mode setting unit is the same as a link mode set in the external apparatus, the transmission unit adjusts the link setting for the digital interface to a value corresponding to the link mode which is the same between the transmission apparatus and the external apparatus.

(3)

The transmission apparatus according to (2),

wherein the transmission unit is notified by the external apparatus that the link mode set by the link mode setting unit is the same as the link mode set in the external apparatus.

(4)

The transmission apparatus according to (2) or (3), further including:

a display control unit configured to control a display of a user interface screen for setting of a link mode performed in the link mode setting unit.

(5)

The transmission apparatus according to any of (1) to (4),

wherein the link mode has options including at least any one of a performance priority mode in which performance of the apparatus is a high priority, a content priority mode in which a setting is changed according to the type of a content, and an energy saving mode in which power consumption of the apparatus is reduced.

(6)

The transmission apparatus according to any of (1) to (5),

wherein the digital interface is an interface compliant with the Mobile High-definition Link (MHL) standard.

(7)

A transmission method including:

a transmission step of adjusting a link setting for a digital interface with respect to an external apparatus, and transmitting content data to the external apparatus through a transmission channel according to a value of the link setting,

wherein the transmission step includes adjusting the link setting for the digital interface according to setting information about a link mode.

(8)

A reception apparatus including:

a reception unit configured to adjust a link setting for a digital interface between the reception apparatus and an external apparatus, and receive content data from the external apparatus through a transmission channel according to a value of the link setting,

wherein the reception unit adjusts the link setting for the digital interface according to setting information about a link mode.

(9)

The reception apparatus according to (8), further including:

a link mode setting unit configured to select and set one of a plurality of link modes,

wherein when the link mode set by the link mode setting unit is the same as a link mode set in the external apparatus, the reception unit adjusts the link setting for the digital interface to a value corresponding to the link mode which is the same between the reception apparatus and the external apparatus.

(10)

The reception apparatus according to (9),

wherein the reception unit receives, from the external apparatus, the value corresponding to the link mode which is the same between the reception apparatus and the external apparatus.

(11)

The reception apparatus according to (9) or (10), further including:

a display control unit configured to perform control to provide an alert display when the link mode set by the link mode setting unit is not the same as the link mode set in the external apparatus.

(12)

The reception apparatus according to any of (9) to (11), further including:

a display control unit configured to control a display of a user interface screen for setting of a link mode performed in the link mode setting unit.

(13)

The reception apparatus according to any of (8) to (12),

wherein the link mode has options including at least any one of a performance priority mode in which performance of the apparatus is a high priority, a content priority mode in which a setting is changed according to the type of a content, and an energy saving mode in which power consumption of the apparatus is reduced.

(14)

The reception apparatus according to any of (8) to (13),

wherein the digital interface is an interface compliant with the Mobile High-definition Link (MHL) standard.

(15)

A reception method including:

a reception step of adjusting a link setting for a digital interface with respect to an external apparatus, and receiving content data from the external apparatus through a transmission channel according to a value of the link setting,

wherein the reception step includes adjusting the link setting for the digital interface according to setting information about a link mode.

### REFERENCE SIGNS LIST

10 image display system
100 mobile phone
101 CPU
102 user operation unit
103 display control unit
104 display unit
105 3G/4G modem
106 camera unit
107 recording/reproduction unit
108 transmission process unit
109 MHL transmission unit
110 MHL terminal
111 power supply unit
200 television set
201 CPU
202 user operation unit
203 display control unit
204 MHL terminal
205 MHL reception unit
206 reception process unit
207 tuner
208 antenna terminal
209 switching unit
210 display unit
211 power supply unit
300 MHL cable
400 digital camera
401 CPU
402 user operation unit
403 display control unit
404 display unit
405 camera unit
406 recording/reproduction unit
407 transmission process unit
408 MHL transmission unit
409 MHL terminal
410 power supply unit

1. A transmission apparatus comprising:
a transmission unit configured to adjust a link setting for a digital interface between the transmission apparatus and an external apparatus, and transmit content data to the external apparatus through a transmission channel according to a value of the link setting,
wherein the transmission unit adjusts the link setting for the digital interface according to setting information about a link mode.

2. The transmission apparatus according to claim 1, further comprising:
a link mode setting unit configured to select and set one of a plurality of link modes,
wherein when the link mode set by the link mode setting unit is the same as a link mode set in the external apparatus, the transmission unit adjusts the link setting for the digital interface to a value corresponding to the link mode which is the same between the transmission apparatus and the external apparatus.

3. The transmission apparatus according to claim 2,
wherein the transmission unit is notified by the external apparatus that the link mode set by the link mode setting unit is the same as the link mode set in the external apparatus.

4. The transmission apparatus according to claim 2, further comprising:
a display control unit configured to control a display of a user interface screen for setting of a link mode performed in the link mode setting unit.

5. The transmission apparatus according to claim 1,
wherein the link mode has options including at least any one of a performance priority mode in which performance of the apparatus is a high priority, a content priority mode in which a setting is changed according to the type of a content, and an energy saving mode in which power consumption of the apparatus is reduced.

6. The transmission apparatus according to claim 1,
wherein the digital interface is an interface compliant with the Mobile High-definition Link (MHL) standard.

7. A transmission method comprising:
a transmission step of adjusting a link setting for a digital interface with respect to an external apparatus, and transmitting content data to the external apparatus through a transmission channel according to a value of the link setting,
wherein the transmission step includes adjusting the link setting for the digital interface according to setting information about a link mode.

8. A reception apparatus comprising:
a reception unit configured to adjust a link setting for a digital interface between the reception apparatus and an external apparatus, and receive content data from the external apparatus through a transmission channel according to a value of the link setting,
wherein the reception unit adjusts the link setting for the digital interface according to setting information about a link mode.

9. The reception apparatus according to claim 8, further comprising:
a link mode setting unit configured to select and set one of a plurality of link modes,
wherein when the link mode set by the link mode setting unit is the same as a link mode set in the external apparatus, the reception unit adjusts the link setting for the digital interface to a value corresponding to the link mode which is the same between the reception apparatus and the external apparatus.

10. The reception apparatus according to claim 9,
wherein the reception unit receives, from the external apparatus, the value corresponding to the link mode which is the same between the reception apparatus and the external apparatus.

11. The reception apparatus according to claim 9, further comprising:
a display control unit configured to perform control to provide an alert display when the link mode set by the link mode setting unit is not the same as the link mode set in the external apparatus.

12. The reception apparatus according to claim 9, further comprising:
a display control unit configured to control a display of a user interface screen for setting of a link mode performed in the link mode setting unit.

13. The reception apparatus according to claim 8,
wherein the link mode has options including at least any one of a performance priority mode in which performance of the apparatus is a high priority, a content priority mode in which a setting is changed according to the type of a content, and an energy saving mode in which power consumption of the apparatus is reduced.

14. The reception apparatus according to claim 8,
wherein the digital interface is an interface compliant with the Mobile High-definition Link (MHL) standard.

15. A reception method comprising:
a reception step of adjusting a link setting for a digital interface with respect to an external apparatus, and receiving content data from the external apparatus through a transmission channel according to a value of the link setting,
wherein the reception step includes adjusting the link setting for the digital interface according to setting information about a link mode.
